(19) United States
(12) Patent Application Publication
(10) Pub. No.: US 2022/0194801 A1
(43) Pub. Date: Jun. 23, 2022

(54) SURFACE LAYER POROUS GRAPHITE SHEET

(71) Applicant: KANEKA CORPORATION, Osaka (JP)

(72) Inventors: Motoaki Kobayashi, Settsu-shi (JP); Teruo Matsutani, Settsu-shi (JP); Keisuke Inaba, Settsu-shi (JP)

(73) Assignee: KANEKA CORPORATION, Osaka (JP)

(21) Appl. No.: 17/654,395

(22) Filed: Mar. 10, 2022

Related U.S. Application Data
(63) Continuation of application No. PCT/JP2020/030144, filed on Aug. 6, 2020.

(30) Foreign Application Priority Data
Sep. 12, 2019 (JP) 2019-166373

(51) Int. Cl. C01B 32/21; C09K 5/14

(52) U.S. Cl. CPC C01B 32/21; C09K 5/14

(57) ABSTRACT

A graphite sheet can be combined with a base even without the need for use of an adhesive. A surface layer porous graphite sheet includes: a graphite layer and a porous layer arranged on one or both surfaces of the graphite layer. The porous layer has pores having a pore diameter X that is measured on a surface of the porous layer and pores having a pore diameter Y that is measured inside the porous layer and that is larger than the pore diameter X. A porosity in a cross section of the surface layer porous graphite sheet satisfies a predetermined condition.

### TECHNICAL FIELD

The present invention relates to a surface layer porous graphite sheet.

### BACKGROUND ART

There has been known a technology for combining a base and a graphite sheet with each other so that the graphite sheet can be used as a heat dissipation member. The combining is typically carried out by attaching the graphite sheet to the base with use of an adhesive.

For example, Patent Literature 1 discloses a thermoelectric conversion device including: an electrically-insulative ceramic substrate; a graphite sheet that is integrated with the ceramic substrate and that has a favorable thermal conductivity; thermoelectric conversion elements supported by the ceramic substrate; and a heating element disposed on the side of the graphite sheet. In Patent Literature 1, the graphite sheet is attached to one surface of the electrically-insulative ceramic substrate with use of a thermal conductive adhesive, a thermal conductive double-sided adhesive tape, or the like.

### CITATION LIST

### Patent Literature

[Patent Literature 1]

Japanese Patent Application Publication, Tokukai, No. 2003-174204

### SUMMARY OF INVENTION

### Technical Problem

Unfortunately, however, with conventional techniques such as that described above, the adhesive may sometimes be a bottleneck in the properties of the base-graphite sheet composite. Specifically, the adhesive can cause the following problems: the adhesive functions as a thermal resistance; and/or the heat resistance of the adhesive can limit the heat resistance of the composite. These problems are new problems found by the inventors of the present invention.

For example, in a case where a ceramic is used as the base, the following problems may occur. The ceramic has a high heatproof temperature, and can be used even under a high temperature environment, advantageously. However, when a graphite sheet and a ceramic are bonded to each other with use of an adhesive, a resulting bonded product should be sintered at 900° C. or more. The adhesive cannot endure the high temperature. Meanwhile, in a case where a brazing material is used to bond the graphite sheet and the ceramic to each other, migration of the brazing material can occur due to the high temperature.

In view of this, there has been a demand for a graphite sheet that can be combined with a base even without the need for use of an adhesive.

An aspect of the present invention has an object to provide a graphite sheet that can be combined to a base even without the need for use of an adhesive.

### Solution to Problem

A surface layer porous graphite sheet in accordance with an aspect of the present invention includes:

a graphite layer; and

a first porous layer arranged on a first major surface of the graphite layer, wherein

the first porous layer comprises pores that extend from a surface of the first porous layer into an inside portion of the first porous layer, each pore having a pore surface diameter X that is measured at the surface of the first porous layer and a pore inner diameter Y that is measured in the inside the portion of the first porous layer and that is larger than the pore surface diameter X,

in a cross section of the surface layer porous graphite sheet as viewed in a direction perpendicular to the layering direction of the graphite layer and the first porous layer, a porosity of an area A is larger than a porosity of an area B,

where:

the area A is an area corresponding to 20% of a thickness of the surface layer porous graphite sheet as measured towards the graphite layer from the surface of the first porous layer, and

the area B is an area of a thickness of the surface layer porous graphite sheet not including the area A.

A method for producing a surface layer porous graphite sheet in accordance with an aspect of the present invention includes the steps of:

providing a laminated resin sheet including
a resin sheet and
a pore forming agent-containing resin layer laminated on a first surface of the resin sheet, said at least one the pore forming agent-containing resin layer containing a pore forming agent that is volatilized upon heated; and

subjecting the laminated resin sheet to heat treatment to graphitize the laminated resin sheet, the heat treatment being carried out at a temperature equal to or higher than a temperature at which the pore forming agent is volatilized.

### Advantageous Effects of Invention

An aspect of the present invention provides a graphite sheet that can be combined with a base even without the need for use of an adhesive.

### BRIEF DESCRIPTION OF DRAWINGS

FIG. 1 is a view schematically illustrating a surface layer porous graphite sheet in accordance with an embodiment of the present invention.

FIG. 2 is a view schematically illustrating a surface layer porous graphite sheet in accordance with an embodiment of the present invention. FIG. 2 illustrates an area A and an area B in a cross section of the surface layer porous graphite sheet.

FIG. 3 is a view schematically illustrating a surface layer porous graphite sheet in accordance with another embodiment of the present invention. FIG. 3 illustrates an area A and an area B in a cross section of the surface layer porous graphite sheet having porous layers provided on both major surfaces of the surface layer porous graphite sheet.

FIG. 4 is a view schematically illustrating a cross section of a composite material in accordance with an embodiment of the present invention.

FIG. 5 is a view schematically illustrating a method for producing a surface layer porous graphite sheet in accordance with an embodiment of the present invention.

FIG. 6 is a view schematically illustrating a graphite sheet having a surface provided with a porous layer, the graphite sheet having been produced by a method that is not a production method in accordance with an embodiment of the present invention.

### DESCRIPTION OF EMBODIMENTS

The following description will discuss embodiments of the present invention in detail. Specifically, the present invention is not limited to the embodiments below, and can therefore be modified by a skilled person in the art within the scope of the claims. The present invention also encompasses, in its technical scope, any embodiment derived by combining technical means disclosed in differing embodiments.

Note that the expression “A to B”, representing a numerical range, herein means “not less than A and not more than B” unless otherwise specified in this specification.

(1. Surface Layer Porous Graphite Sheet)

[1-1. Structure of Surface Layer Porous Graphite Sheet]

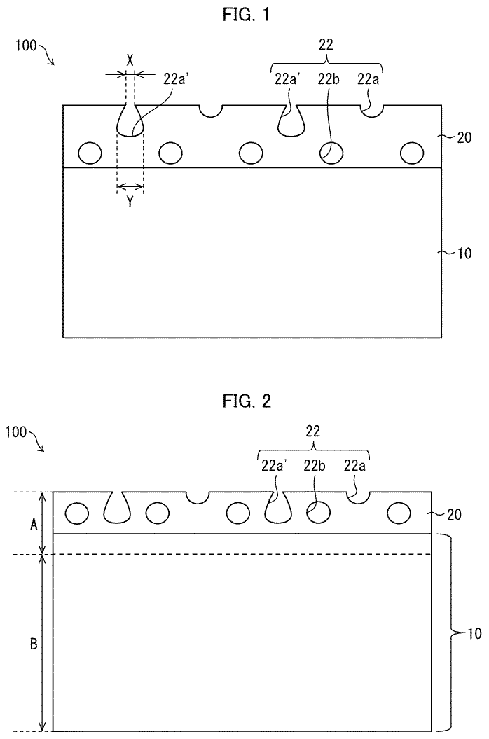

The following description will discuss, with reference to FIGS. 1 to 4, a structure of a surface layer porous graphite sheet in accordance with an aspect of the present invention.

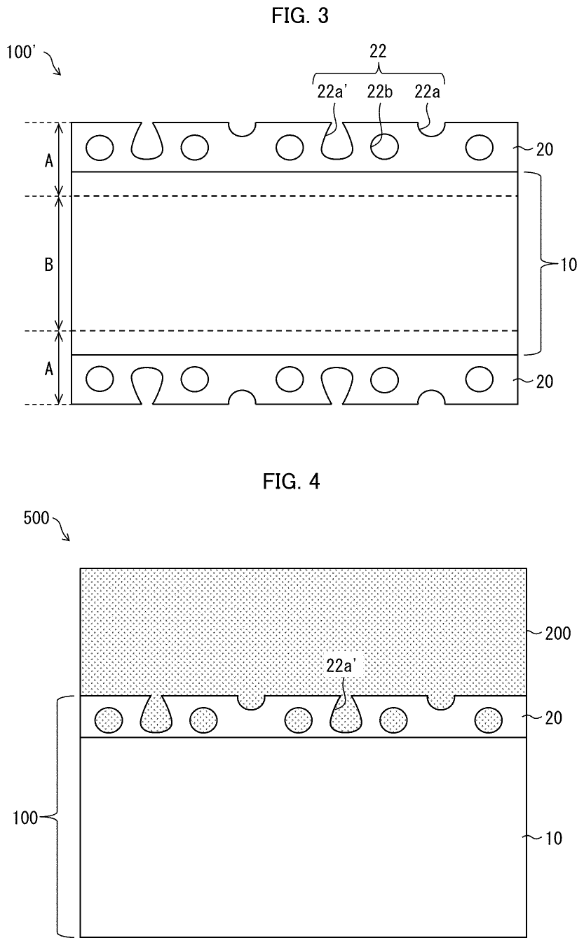

A surface layer porous graphite sheet 100 includes a porous layer 20 and a graphite layer 10 adjacent to the porous layer 20. The porous layer 20 is a part mainly constituted by porous graphite, and provides the surface layer porous graphite sheet 100 with adhesiveness with respect to a base 200 (particularly, a ceramic base) when the porous layer 20 is combined with the surface layer porous graphite sheet 100. The graphite layer 10 is a part mainly constituted by graphite having less pores than the porous layer 20, and has a high thermal conductivity and a heat dissipation effect. In FIG. 1, the porous layer 20 is provided on one major surface of the surface layer porous graphite sheet 100. Alternatively, the porous layers 20 may be provided on both major surfaces of the surface layer porous graphite sheet 100 (see a surface layer porous graphite sheet 100′ in FIG. 3).

The porous layer 20 has a large number of pores 22. Some (pores 22a) of the pores 22 have openings on a surface of the surface layer porous graphite sheet 100. Another ones (pores 22b) of the pores 22 are buried in the porous layer 20. The pores 22 include pores 22a′ each having a pore diameter X (also known as pore surface diameter X) that is measured on the surface of the porous layer 20 and a pore diameter Y (also known as pore inner diameter Y) that is measured inside the porous layer 20 and that is larger than the pore diameter X (see FIG. 1). The relation between the pore diameters X and Y can be checked by, e.g., seeing a photograph of a cross section of the surface layer porous graphite sheet 100.

When the surface layer porous graphite sheet 100 is combined with the base 200, the base 200 intrudes into the pores 22a′, each of which has the pore diameter X and the pore diameter Y larger than the pore diameter X. Thus, the pores 22a′ having the pore diameter X and the pore diameter Y larger than the pore diameter X provide the surface layer porous graphite sheet 100 with an anchor effect with respect to the base 200, and consequently enhances the adhesiveness between the surface layer porous graphite sheet 100 and the base 200 (see FIG. 4).

Conventionally, the graphite sheet is difficult to be directly combined with a base such as a metal, a ceramic, or the like, and therefore the combining of the graphite sheet with the base has been typically carried out with use of an adhesive. Meanwhile, thanks to the pores 22a′ having the pore diameter X and the pore diameter Y larger than the pore diameter X, the surface layer porous graphite sheet 100 can be directly combined with the base even without use of the adhesive.

Thus, the pores 22a′ having the pore diameter X and the pore diameter Y greater than the pore diameter X give the adhesiveness between the surface layer porous graphite sheet 100 and the base 200. Therefore, the condition that “the porous layer 20 has the pores 22 including the pores 22a′ having the pore diameter X that is measured on the surface of the porous layer 20 and the pore diameter Y that is measured inside the porous layer 20 and that is larger than the pore diameter X” can alternatively be expressed by the adhesiveness between the surface layer porous graphite sheet 100 and the base 200. Specifically, when an adhesiveness test is carried out in the below-described procedure and consequently a surface of a graphite sheet is not entirely separated from a ceramic at the interface therebetween, this state can be considered as a state where “the porous layer 20 has the pores 22 including the pores 22a′ having the pore diameter X that is measured on the surface of the porous layer 20 and the pore diameter Y that is measured inside the porous layer 20 and that is larger than the pore diameter X” (for details of the test method, see the later-described Examples, for example).

1. A ceramic material, an alumina-based ceramic adhesive, or the like before being sintered is sandwiched between two surface layer porous graphite sheets 100. At this time, the porous layers 20 are in contact with the ceramic material before being sintered.
2. A laminate obtained in “1.” is subjected to heat treatment, so that a composite material is obtained.
3. An end of the two surface layer porous graphite sheets is pinched with a jig, and one of the two surface layer porous graphite sheets 100 is vertically stripped off, at a speed of 10 mm/sec, so that the one of the two surface layer porous graphite sheets 100 forms an angle of 180°.
4. It is checked whether the surface layer porous graphite sheet 100 is separated from the ceramic at the interface therebetween and/or whether delamination inside the surface layer porous graphite sheet 100 has occurred.

The porous layer 20 is localized in the surface layer of the surface layer porous graphite sheet 100. That is, the graphite sheet is not entirely porous. This is expressed by the condition that “in a cross section of the surface layer porous graphite sheet 100 as viewed in a direction perpendicular to the layering direction of the graphite layer and the first porous layer, a porosity of an area A is larger than a porosity of an area B” (see FIGS. 2 and 3).

Area A: An area corresponding to 20% of a thickness of the surface layer porous graphite sheet 100 as measured towards the graphite layer from the surface of the first porous layer 20.
Area B: An area of the surface layer porous graphite sheet 100 not including the area A.

FIG. 2 shows a surface layer porous graphite sheet 100 having a porous layer 20 provided in only one surface layer thereof. In the surface layer porous graphite sheet 100 configured as such, the areas A and B are as those shown in FIG. 2. Meanwhile, FIG. 3 shows a surface layer porous graphite sheet 100′ having porous layers 20 provided in both surface layers thereof. In the surface layer porous graphite sheet 100′ configured as such, the areas A and B are as those shown in FIG. 3.

Note that the “surface of the surface layer porous graphite sheet 100 on which surface the porous layer 20 resides” means a surface in which pores 22a′ each having a pore diameter X and a pore diameter Y larger than the pore diameter X exist.

As is clear from FIGS. 2 and 3, a boundary between the areas A and B does not always coincide with a boundary between the graphite layer 10 and the porous layer 20. The boundary between the areas A and B may be located in the graphite layer 10 or in the porous layer 20. However, it is clear that the area A includes, in its most part, the porous layer 20 and the area B includes, in its most part, the graphite layer 10. Therefore, in a cross section obtained by vertically cutting off the surface layer porous graphite sheet 100, a porosity of the area A is larger than a porosity of the area B.

Note that the porosity in the cross section can be calculated from a micrograph of the cross section with use of known image processing software, for example.

The “surface obtained by vertically cutting off the surface layer porous graphite sheet 100” may be a “cross section obtained by cutting off the surface layer porous graphite sheet 100 vertically with respect to individual layers of graphite constituting the surface layer porous graphite sheet 100”. Typically, the former and the latter are substantially identical, in view of the structure of a generally-used graphite sheet.

[1-2. Properties of Surface Layer Porous Graphite Sheet]

The lower limit of the thickness of the porous layer 20 is preferably not less than 1 μm, more preferably not less than 3 μm, even more preferably not less than 5 μm. By setting the thickness of the porous layer so as to be not less than 1 μm, it is highly probable that, in the later-described production method, a thickness of a pore forming agent-containing resin layer 40 is greater than a particle diameter of a pore forming agent 42 to be used. Thus, the pores 22a′ having the pore diameter X and the pore diameter Y greater than the pore diameter X are likely to be formed.

The upper limit of the thickness of the porous layer 20 is preferably not more than 30 μm, more preferably not more than 20 μm, even more preferably not more than 10 μm. The porous layer 20 has a lower thermal conductivity than that of the graphite layer 10. Therefore, by setting the thickness of the porous layer 20 so as to be not more than 30 μm, the surface layer porous graphite sheet 100 tends to have a sufficient thermal conductivity in its entirety.

The lower limit of the thickness of the surface layer porous graphite sheet 100 is preferably not less than 20 μm, more preferably not less than 30 μm. The upper limit of the thickness of the surface layer porous graphite sheet 100 is preferably not more than 100 μm, more preferably not more than 75 μm. The surface layer porous graphite sheet 100 having a thickness within the above range can be expected to have an effect of enhancing the heat dissipation property of the base, even when the porous layer is provided thereto. In addition, the surface layer porous graphite sheet 100 having a thickness within the above range has flexibility, and therefore is easy to be handled.

The surface layer porous graphite sheet 100 has a thermal conductivity in an in-plane direction of preferably not less than 800 W/mK, more preferably not less than 1000 W/mK, even more preferably not less than 1200 W/mK, further more preferably not less than 1400 W/mK. Note that the upper limit of the thermal conductivity in the in-plane direction of the surface layer porous graphite sheet 100 is not limited to any particular one, but may be set to be not more than 2000 W/mK.

Setting the thermal conductivity in the in-plane direction so as to fall within the above range allows the surface layer porous graphite sheet 100 to be suitably used as a heat dissipation member. The thermal conductivity in the in-plane direction can be measured by, for example, a measurement method described in the later-described Examples.

The surface layer porous graphite sheet 100 has a tensile strength of preferably not less than 10 MPa, more preferably not less than 20 MPa. Note that the upper limit of the tensile strength of the surface layer porous graphite sheet 100 is not limited to any particular one, but may be not more than 200 MPa.

It can be said that the surface layer porous graphite sheet 100 having a tensile strength within the above range has a sufficient strength as a material. A method for measuring the tensile strength can be, for example, a method defined in ASTM-D-882.

[2. Composite Material and Electronic Part]

An aspect of the present invention is a composite material 500 constituted by the surface layer porous graphite sheet 100 and the base 200 laminated with the surface layer porous graphite sheet 100. The base 200 may be an inorganic material or an organic material. For example, in a case where the composite material is used as a material of an electronic part or a material of a cooling part of an electronic material, the base 200 is preferably an inorganic material. Examples of the inorganic material encompass a metal and a ceramic.

As the base 200, a known metal material can be used as appropriate. Specific examples of the metal material encompass gold, silver, copper, nickel, aluminum, molybdenum, tungsten, and an alloy containing any of them.

As the base 200, a known ceramic material can be used as appropriate. Specific examples of the ceramic material encompass alumina, zirconia, silicon carbide, silicon nitride, boron nitride, and aluminum nitride.

The thickness of the composite material 500 is preferably not less than 25 μm, more preferably not less than 50 μm. The thickness of the composite material 500 is preferably not more than 50 mm, more preferably not more than 10 mm. The composite material 500 having a thickness within the above range can achieve sufficient strength and sufficient heat dissipation property.

An aspect of the present invention is an electronic part containing the composite material 500 or a cooling part of an electronic material containing the composite material 500. Specific examples of the electronic part encompass a glass epoxy substrate, a fluorine substrate, a metal substrate, and a ceramic substrate. Specific examples of the cooling part of the electronic material encompass a heat spreader, a heat sink, a heat pipe, and a heat dissipating fin.

(3. Method for Producing Surface Layer Porous Graphite Sheet)

[3-1. Providing Step]

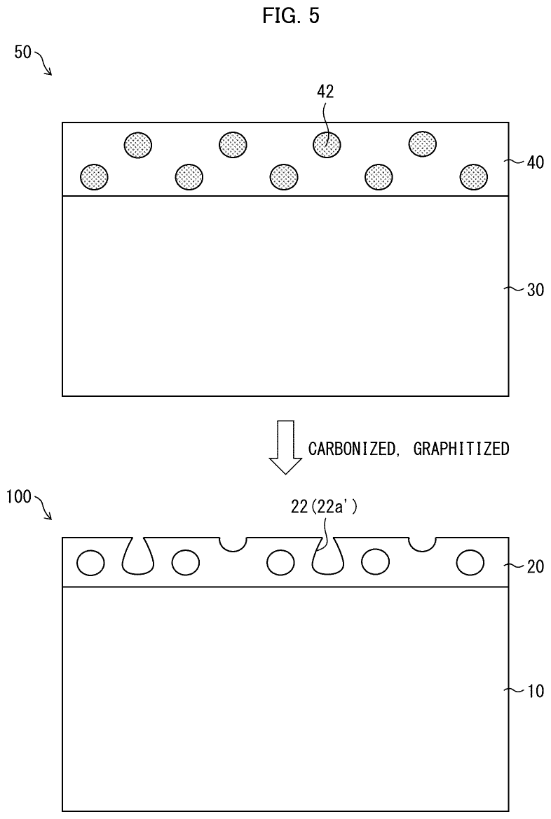

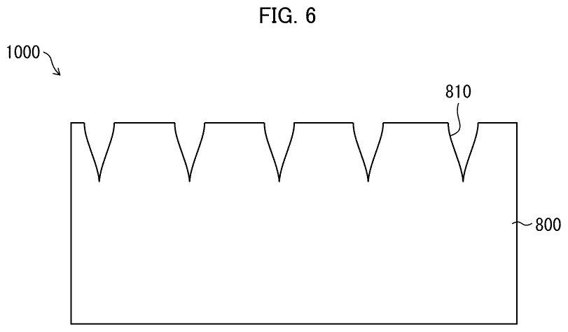

The following description will discuss, with reference to FIG. 5, a method for producing a surface layer porous graphite sheet in accordance with an aspect of the present invention.

The production method includes a step of providing a laminated resin sheet 50 (upper part of FIG. 5). The laminated resin sheet 50 is a sheet including a resin sheet 30 and a pore forming agent-containing resin layer(s) 40 laminated on one or both surfaces of the resin sheet 30. The pore forming agent-containing resin layer 40 contains the pore forming agent 42 that is volatilized upon heated.

The resin sheet 30 may also contain a substance that is volatilized upon heated (e.g., calcium phosphate, calcium hydrogen phosphate, calcium carbonate, or silica). This substance is a substance for increasing an interlayer distance between the individual layers of graphite constituting the graphite layer 10. Note that a content of the pore forming agent 42 in the pore forming agent-containing resin layer 40 is quite larger than a content, in the resin sheet 30, of the substance that is volatilized upon heated.

The content of the pore forming agent 42 in the pore forming agent-containing resin layer 40 is preferably not less than 7 wt %, more preferably not less than 10 wt %, even more preferably not less than 15 wt %, further more preferably not less than 20 wt %, still more preferably not less than 25 wt %, yet more preferably not less than 30 wt %. The content of the pore forming agent 42 can be obtained by the following formula: “Content of pore forming agent 42=weight of pore forming agent 42/weight of resin solid content in pore forming agent-containing resin layer 40 (except for weight of pore forming agent 42)×100”. That is, as will be described later, in a case where the pore forming agent-containing resin layer 40 is formed by application of a varnish, the weight of a solvent contained in the varnish does not affect the content of the pore forming agent 42 in the pore forming agent-containing resin layer 40.

Note that the upper limit of the content of the pore forming agent 42 in the pore forming agent-containing resin layer 40 is preferably not more than 75 wt %, more preferably not more than 60 wt %, even more preferably not more than 50 wt %.

Meanwhile, the content, in the resin sheet 30, of the substance that is volatilized upon heated is preferably not more than 1 wt %, more preferably not more than 0.5 wt %, even more preferably not more than 0.2 wt %. The above-described content can be obtained by the following formula: “Content of substance that is volatilized upon heated=weight of substance that is volatilized upon heated/weight of resin solid content in resin sheet 30 (except for weight of substance that is volatilized upon heated)×100”.

When the “content of the pore forming agent 42 in the pore forming agent-containing resin layer 40” and the “content, in the resin sheet 30, of the substance that is volatilized upon heated” thus obtained are compared to each other, the former is preferably equal to or greater than 10 times the latter, more preferably equal to or greater than 50 times the latter, even more preferably equal to or greater than 100 times the latter.

[3-2. Graphitizing Step]

The production method in accordance with an aspect of the present invention includes a graphitizing step of subjecting the laminated resin sheet 50 to heat treatment to graphitize the laminated resin sheet 50. The heat treatment is carried out at a temperature equal to or higher than a temperature at which the pore forming agent 42 is volatilized.

In the graphitizing step, the laminated resin sheet 50 is subjected to heat treatment at a temperature equal to or higher than the temperature at which the pore forming agent 42 is volatilized. Thus, in the graphitizing step, the pore forming agent 42 contained in the pore forming agent-containing resin layer 40 is volatilized. The heat treatment is carried out until the laminated resin sheet 50 is graphitized. Thus, at the end, a surface layer porous graphite sheet 100 having, in its one or both surface layers, a porous layer(s) 20 is obtained.

Here, as shown in the upper part of FIG. 5, at least part of the pore forming agent 42 is distributed in a state where the at least part of the pore forming agent 42 is buried in the pore forming agent-containing resin layer 40. Thus, as a result of forming the pores 22 by volatilizing the pore forming agent 42, the pores 22 include the pores 22a′ having the pore diameter X and the pore diameter Y, the pore diameter X being smaller than the pore diameter Y.

Meanwhile, a graphite sheet having a surface layer whose pores are formed by a conventional technique (e.g., laser irradiation) cannot have the pores 22a′ having the pore diameter X and the pore diameter Y, the pore diameter X being smaller than the pore diameter Y. FIG. 6 shows a graphite sheet 1000, produced by a typical conventional technique, having a surface with pores. Pores 810 provided to the graphite sheet 1000 (i) increase their pore diameters as their proximity to the surface or (ii) have substantially constant pore diameters in their entireties.

In addition, the production method in accordance with an embodiment of the present invention graphitizes the laminated resin sheet 50. That is, the resin sheet 30 and the pore forming agent-containing resin layer 40 are graphitized in a state where the resin sheet 30 and the pore forming agent-containing resin layer 40 are laminated with each other. Consequently, a porous layer 20 is localized in a surface layer of a graphite sheet thus obtained. Conversely, if a pore forming agent is evenly contained in a resin sheet before being subjected to the graphitizing step, a resultant graphite sheet will be porous in its entirety.

In the graphitizing step, the laminated resin sheet 50 is subjected to heat treatment at a temperature of 700° C. to 1400° C. so as to be carbonized, and then is subjected to heat treatment at a temperature of 2000° C. to 3500° C. so as to be graphitized. The temperature at which the pore forming agent 42 is volatilized is not limited to any particular one, provided that the temperature is within the above-indicated temperature range. However, it is preferable that the pore forming agent 42 be volatilized at the stage of graphitization, rather than at the stage of carbonization. That is, the temperature at which the pore forming agent 42 is volatilized is preferably 1400° C. to 3500° C., more preferably 2000° C. to 3000° C.

[3-3. Method for Producing Laminated Resin Sheet]

A laminated resin sheet 50 can be produced by laminating a pore forming agent-containing resin layer(s) 40 on one or both surfaces of a resin sheet 30. In one example, a laminated resin sheet 50 can be produced by a wet method that applies a resin varnish containing a pore forming agent 42 to one or both surfaces of a resin sheet 30 and then dries a resultant product. In another example, a layer(s) of a resin varnish containing a pore forming agent 42 is provided to one or both surfaces of a precursor of a resin sheet 30, and then a resin sheet 30 and a pore forming agent-containing resin layer 40 can be produced at the same time.

In a case where the laminated resin sheet 50 is produced by the above-described wet method, the resin varnish may be applied on the resin sheet 30 by any method. The application method may be a known method such as a gravure coater method, a dip coater method, a bar coater method, or a die coater method.

The thicknesses of the resin sheet 30, the pore forming agent-containing resin layer 40, and the laminated resin sheet 50 can be selected as appropriate in accordance with desired thicknesses of the graphite layer 10, the porous layer 20, and the surface layer porous graphite sheet 100. In one example, the resin sheet 30 has a thickness of preferably 25 μm to 180 μm, more preferably 50 μm to 130 μm. The pore forming agent-containing resin layer 40 has a thickness (thickness in a dried state) of preferably 1 μm to 60 μm, more preferably 5 μm to 20 μm. The laminated resin sheet 50 has a thickness (thickness in a dried state) of preferably 40 μm to 200 μm, more preferably 60 μm to 150 μm.

(Resin Sheet)

The material of the resin sheet 30 is not limited to any particular one, provided that the material is a substance that is graphitized upon heat treatment. In one example, the material of the resin sheet 30 is a polyimide sheet. In another example, the material of the resin sheet 30 is a carbonized sheet obtained by carbonizing a polyimide sheet at a high temperature (e.g., 800° C. or higher).

The polyimide sheet is a polyimide sheet made from raw materials that are a dianhydride component and a diamine component.

Specific examples of the dianhydride component encompass a pyromellitic dianhydride, 2,3,6,7-naphthalene tetracarboxylic dianhydride, 3,3′,4,4′-biphenyl tetracarboxylic dianhydride, 1,2,5,6-naphthalene tetracarboxylic dianhydride, 2,2′,3,3′-biphenyl tetracarboxylic dianhydride, 3,3′,4,4′-benzophenone tetracarboxylic dianhydride, 2,2-bis(3,4-dicarboxyphenyl)propane dianhydride, 3,4,9,10-perylene tetracarboxylic dianhydride, 1,1-(3,4-dicarboxyphenyl) ethane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, oxydiphthalic dianhydride, bis(3,4-dicarboxyphenyl)sulfone dianhydride, p-phenylene bis(trimellitic acid monoester acid anhydride), ethylenebis(trimellitic acid monoester acid anhydride), bisphenol A bis(trimellitic acid monoester acid anhydride), and derivatives thereof.

Specific examples of the diamine component encompass 4,4′-diaminodiphenylether, p-phenylene diamine, 4,4′-diaminodiphenyl methane, benzidine, 3,3′-dichlorobenzidine, 4,4′-diaminodiphenyl sulfide, 3,3′-diaminodiphenyl sulfone, 4,4′-diaminodiphenyl sulfone, 3,3′-diaminodiphenyl ether, 3,4′-diaminodiphenyl ether, 1,5-diaminonaphthalene, 4,4′-diaminodiphenyldiethyl silane, 4,4′-diaminodiphenyl silane, 4,4′-diaminodiphenyl ethyl phosphine oxide, 4,4′-diaminodiphenyl N-methylamine, 4,4′-diaminodiphenyl N-phenylamine, 1,3-diaminobenzene, 1,2-diaminobenzene, and analogues thereof.

Each of these examples may be used alone, or in combinations of two or more.

(Pore Forming Agent)

The material of the pore forming agent 42 is not limited to any particular one, provided that the material is a substance that is, upon heat treatment, volatilized and forms pores. In one embodiment, the pore forming agent 42 is at least one kind selected from the group consisting of metal oxides, metal salts, metal nitrides, metal carbides, and metal powders.

Specific examples of the metal oxide encompass magnesium oxide, aluminum oxide, calcium oxide, titanium oxide, zirconium oxide, hafnium oxide, gallium oxide, cerium oxide, nickel oxide, chromium oxide, and yttrium oxide. Examples of the metal salt encompass magnesium carbonate, calcium carbonate, calcium phosphate, and sodium phosphate. Examples of the metal nitride encompass titanium nitride, zirconium nitride, niobium nitride, tantalum nitride, and chromium nitride. Examples of the metal carbide encompass tungsten carbide, molybdenum carbide, titanium carbide, tantalum carbide, and niobium carbide. Examples of the metal powder encompass magnesium powder, molybdenum powder, tantalum powder, tungsten powder, nickel powder, zirconium powder, hafnium powder, and titanium powder.

Among the substances listed above, at least one kind selected from magnesium oxide, magnesium carbonate, and aluminum oxide is preferable. These substances are also advantageous in that they are available at low cost, they can exist stably even in the air, they have a high melting point, and they are less dangerous. From the viewpoint of obtaining the porous layer 20 having favorable adhesiveness to the base 200, the pore forming agent 42 is preferably at least one kind selected from the group consisting of magnesium oxide and magnesium carbonate.

The pore forming agent 42 has, as a volume-based average particle diameter (D50), a particle diameter of preferably 0.1 μm to 20 μm, more preferably 1 μm to 10 μm. Setting the particle diameter of the pore forming agent 42 so as to fall within the above range enables to form a pore having a size suitable for adhesion between the porous layer and the base. The volume-based average particle diameter can be measured by a generally-used granulometer.

(Pore Forming Agent-Containing Resin Layer)

The pore forming agent-containing resin layer 40 is not limited to any particular one, provided that the pore forming agent-containing resin layer 40 is a resin layer inside which the pore forming agent 42 is distributed and which remains as carbon after heat treatment. In one embodiment, the pore forming agent-containing resin layer 40 is formed by applying, onto the resin sheet 30, a varnish containing a polyamide acid and a pore forming agent (note that the polyamide acid is a substance that is turned into polyimide when subjected to heat treatment and is then graphitized when subjected to further heat treatment).

Aspects of the present invention can also be expressed as follows:

The present invention encompasses the following aspects:

<1>

A surface layer porous graphite sheet 100 (100′) including:

at least one porous layer 20 residing in one or both surface layers of the surface layer porous graphite sheet 100 (100′); and

a graphite layer 10 adjacent to the at least one porous layer 20, wherein

the at least one porous layer 20 has pores 22 including pores 22a′ each having a pore diameter X that is measured on a surface of the at least one porous layer 20 and a pore diameter Y that is measured inside the at least one porous layer 20 and that is larger than the pore diameter X,

in a cross section obtained by vertically cutting off the surface layer porous graphite sheet 100 (100′), a porosity of an area A is larger than a porosity of an area B,

where:

the area A is an area corresponding to 20% of a thickness of the surface layer porous graphite sheet 100 (100′) from a surface of the surface layer porous graphite sheet 100 (100′) on which surface the at least one porous layer 20 resides, and

the area B is an area of the surface layer porous graphite sheet 100 (100′) except for the area A.

<2>

The surface layer porous graphite sheet 100 (100′) described in <1>, wherein

the surface layer porous graphite sheet 100 (100′) has a thermal conductivity in an in-plane direction of not less than 800 W/mK.

<3>

A composite material 500 including:

the surface layer porous graphite sheet 100 (100′) described in <1> or <2>; and

the base 200 laminated with the surface layer porous graphite sheet 100 (100′).

<4>

An electronic part including a composite material 500 described in <3>.

<5>

A method for producing a surface layer porous graphite sheet 100 (100′), including the steps of:

providing a laminated resin sheet 50 including
a resin sheet 30 and
at least one pore forming agent-containing resin layer 40 laminated on one or both surfaces of the resin sheet 30, the at least one pore forming agent-containing resin layer 40 containing a pore forming agent 42 that is volatilized upon heated; and

subjecting the laminated resin sheet 50 to heat treatment to graphitize the laminated resin sheet 50, the heat treatment being carried out at a temperature equal to or higher than a temperature at which the pore forming agent 42 is volatilized.

<6>

The method described in <5>, wherein

the pore forming agent 42 is at least one kind selected from the group consisting of metal oxides, metal salts, metal nitrides, metal carbides, and metal powders.

<7>

The method described in <5> or <6>, wherein

the pore forming agent 42 is at least one kind selected from the group consisting of magnesium oxide, magnesium carbonate, and aluminum oxide.

### EXAMPLES

The following will discuss in detail Examples of the present invention. However, the present invention is not limited to the following Examples.

(Method for Evaluating Properties of Graphite Sheet)

[Adhesiveness to Ceramic]

Two graphite sheets obtained in each of Examples and Comparative Examples were prepared. On one surface of one of the two graphite sheets, a ceramic adhesive (available from ThreeBond Holdings Co., Ltd., heat-resistance inorganic adhesive 3732, alumina-based) was applied. The ceramic adhesive was then sandwiched between the two graphite sheets. The surface of the graphite sheet which surface is adjacent to the ceramic adhesive was a surface having a porous layer formed therein. Next, the graphite sheets sandwiching the ceramic adhesive were heated to 1000° C. at a temperature increase rate of 5° C./min in a nitrogen atmosphere. A resultant product was then subjected to heat treatment at 1000° C. for 10 minutes, and a composite material was dried. The composite material thus obtained was cooled to a room temperature. Then, an end of the two surface layer porous graphite sheets was pinched with a jig, and one of the two surface layer porous graphite sheets was vertically stripped off, at a speed of 10 mm/sec, so that the one of the two surface layer porous graphite sheets formed an angle of 180°. In this manner, the adhesiveness was evaluated. The results of the evaluation are as indicated below in order of decreasing excellence in adhesiveness to the ceramic.

A: The graphite sheet was not separated from the ceramic at the interface between the graphite sheet and the ceramic, and only delamination inside the graphite sheet occurred (i.e., the graphite sheet was not separated from the ceramic at all).
B: The graphite sheet was partially separated from the ceramic at the interface between the graphite sheet and the ceramic, and delamination inside the graphite sheet occurred in an area not less than half thereof (i.e., a most part of the graphite sheet was not separated from the ceramic).
C: An area not less than half of the graphite sheet was separated from the ceramic at the interface between the graphite sheet and the ceramic, and delamination inside the graphite sheet occurred in a part of the graphite sheet (i.e., a part of the graphite sheet was not separated from the ceramic).
D: The graphite sheet was entirely separated from the ceramic at the interface between the graphite sheet and the ceramic (i.e., the graphite sheet was completely separated from the ceramic).

[Heat Dissipation Property]

(Thermal Diffusivity)

The thermal diffusivity of the graphite sheet obtained in each of Examples and Comparative Examples was measured with a thermal diffusivity measurement device (“Laser Pit” manufactured by ULVAC-RIKO, Inc.), which employs the light alternating-current method. Used as a sample was a piece of a graphite sheet cut into a shape of 4 mm×40 mm. The measurement conditions were as follows: in an atmosphere of 20° C., with alternating current at 10 Hz.

(Density of Graphite Sheet)

The weight (g) of a 3 cm-square piece of the graphite sheet was divided by the volume (cm³) calculated from the product of the height, the width, and the thickness of the film. Consequently, a density of the graphite sheet was calculated.

(Evaluation of Heat Dissipation Property)

The thermal conductivity in an in-plane direction was obtained by the following formula: “thermal diffusivity×density×specific heat=thermal conductivity in in-plane direction”. In accordance with the obtained value of the thermal conductivity, the heat dissipation property was evaluated. The evaluation was conducted on the basis of the following criteria, indicated in order of decreasing excellence in heat dissipation property.

A: Not less than 1200 W/mK.
B: Not less than 1000 W/mK.
C: Not less than 800 W/mK.
D: Less than 800 W/mK.

### Example 1

[Preparation of Polyamide Acid Varnish (1)]

In a dimethylformamide solution in which 4,4′-diaminodiphenylether (ODA) was dissolved, pyromellitic dianhydride (PMDA) was further added in an equimolar quantity to ODA and dissolved therein. Consequently, a polyamide acid solution containing 18.5 wt % of polyamide acid was obtained. To the polyamide acid solution thus obtained, magnesium oxide was added as a pore forming agent. Consequently, a polyamide acid varnish (1) was obtained. The magnesium oxide was added in an amount with which the concentration of the magnesium oxide with respect to the solid content of the polyamide acid was 30 wt %.

[Production of Laminated Polyimide Film (1)]

On one side of the polyimide sheet (Apical AH available from Kaneka Corporation; thickness of 75 μm), the polyamide acid varnish (1) was applied. The polyamide acid varnish (1) was applied in an amount that allowed the polyamide acid varnish (1) to have a thickness of 10 μm after having been dried. Next, an application product thus obtained was heated by a hot-air oven so as to be dried. The heating history of gradual increases in temperature was as follows: (i) heating was carried out at 100° C. for four minutes, (ii) the temperature was increased to 200° C. to 300° C. over 20 minutes, and (iii) heating was carried out at 400° C. for five minutes. In the above-described manner, a laminated polyimide film (1) (thickness: 85 μm) was produced.

[Production of Graphite Sheet (1)]

The laminated polyimide films (1) (length×width×thickness: 50 mm×50 mm×85 μm) were sandwiched between sheets of graphite (length×width: 70 mm×70 mm). At this time, the laminated polyimide films (1) and the sheets of graphite were laminated such that single layers of each were arranged in an alternating manner. A laminate thus obtained was heated to 1000° C. at a temperature increase rate of 0.5° C./min in a nitrogen atmosphere, and was then subjected to heat treatment at 1000° C. for 10 minutes so as to be carbonized.

Then, the heat treatment temperature was increased to 2800° C. (i.e., maximum temperature of graphitization) at a temperature increase rate of 1.0° C./min, and was then kept at 2800° C. for 10 minutes, whereby graphite sheets (1) were produced. A heat treatment environment in a temperature range from a room temperature to 2200° C. was a vacuum environment, and a heat treatment environment in a temperature range over 2200° C. was an argon atmosphere environment. The graphite sheets (1) were taken out from the sheets of graphite. Then, each of the graphite sheets (1) was sandwiched between PET films (length×width×thickness: 200 mm×200 mm×400 μm), and was compressed with a compression molding machine. During this compression, a pressure of 10 MPa was applied to the graphite sheet (1).

### Example 2

In the procedure for preparing the polyamide acid varnish (1), the concentration of the magnesium oxide with respect to the solid content of the polyamide acid was changed to 10 wt %. In accordance with the procedure thus changed, a polyamide acid varnish (2) was obtained. Graphite sheets (2) were produced in a similar manner to that in Example 1, except that the polyamide acid varnish (2) was used.

### Example 3

In the procedure for preparing the polyamide acid varnish (1), the concentration of the magnesium oxide with respect to the solid content of the polyamide acid was changed to 60 wt %. In accordance with the procedure thus changed, a polyamide acid varnish (3) was obtained. Graphite sheets (3) were produced in a similar manner to that in Example 1, except that the polyamide acid varnish (3) was used.

### Example 4

In the procedure for preparing the polyamide acid varnish (1), the pore forming agent was changed to magnesium carbonate. In accordance with the procedure thus changed, a polyamide acid varnish (4) was obtained. Graphite sheets (4) were produced in a similar manner to that in Example 1, except that the polyamide acid varnish (4) was used.

### Example 5

In the procedure for preparing the polyamide acid varnish (1), the pore forming agent was changed to aluminum oxide. In accordance with the procedure thus changed, a polyamide acid varnish (5) was obtained. Graphite sheets (5) were produced in a similar manner to that in Example 1, except that the polyamide acid varnish (5) was used.

### Example 6

In the procedure for producing the laminated polyimide film (1), the polyamide acid varnish (1) was applied to both surfaces of Apical AH (thickness: 75 μm) available from Kaneka Corporation. The polyamide acid varnish (1) was applied to a single surface in an amount that allowed the polyamide acid varnish (1) to have a thickness of 10 μm after having been dried. Graphite sheets (6) were produced in a similar manner to that in Example 1, except for the above.

### Comparative Example 1

In the procedure for preparing the polyamide acid varnish (1), the pore forming agent was not added. In accordance with the procedure thus changed, a polyamide acid varnish (1a) was obtained. Graphite sheets (1a) were produced in a similar manner to that in Example 1, except that the polyamide acid varnish (1a) was used.

### Comparative Example 2

The graphite sheet (1a) was irradiated with laser, so that pores were formed in a surface layer of the graphite sheet (1a). Consequently, a graphite sheet (2a) was obtained. The density of the pores was approximately 25/cm², and each of the pores was approximately 50 μm in pore diameter and approximately 5 μm in depth.

### Comparative Example 3

While the polyamide acid varnish (1) was being cooled, an imidization catalyst containing acetic anhydride, isoquinoline, and dimethylformamide was added thereto for defoaming. Each of the acetic anhydride and the isoquinoline was in an amount of 1 (one) equivalent with respect to a carboxylic acid group contained in the polyamide acid. A mixed solution thus obtained was then applied to an aluminum foil so as to have a thickness of 75 μm after having been dried. Consequently, a mixed solution layer was obtained. The mixed solution layer on the aluminum foil was dried with use of a hot-air oven and a far-infrared heater.

Drying conditions were as follows. The mixed solution layer on the aluminum foil was first dried at 120° C. for 360 seconds in a hot-air oven so as to yield a gel film having a self-supporting property. The gel film was removed from the aluminum foil, and was fixed to a frame. Thereafter, the gel film was dried by heating carried out in stages, that is, by heating the gel film at 120° C. for 45 seconds, at 275° C. for 60 seconds, at 400° C. for 60 seconds, and at 450° C. for 70 seconds in the hot-air oven and then heating the gel film at 460° C. for 30 seconds with use of the far-infrared heater. A polyimide film (A) having a thickness of 75 μm was thus produced.

The polyimide film (A) was heated in a similar manner to that in Example 1, so that a graphite sheet (3a) was obtained.

### Comparative Example 4

In the procedure for producing the laminated polyimide film (1), the polyamide acid varnish (1a) was applied to a single surface of the polyimide sheet, and then a magnesium oxide powder was sprinkled over the single surface of the polyimide sheet. That is, the polyamide acid varnish not containing a pore forming agent was applied to the surface of the polyimide film, and the pore forming agent was sprinkled thereon. With use of an application product thus obtained, graphite sheets (4a) were obtained in a similar manner to that in Example 1.

(Results)

The evaluation results of the graphite sheets (1) to (6) and (1a) to (4a) are shown in Table 1 below.

TABLE 1

| | Pore-forming | Porous | Pore diameter X | Internal | | Heat dissipation |
|---|---|---|---|---|---|---|
| | agent | layer | Pore diameter Y | state | Adhesiveness | property |
| Ex. 1 | MgO | One surface | With pores of X < Y | Layered | A | B |
| | (30 wt %) | layer | | | | |
| Ex. 2 | MgO | One surface | With pores of X < Y | Layered | C | A |
| | (10 wt %) | layer | | | | |
| Ex. 3 | MgO | One surface | With pores of X < Y | Layered | A | C |
| | (60 wt %) | layer | | | | |
| Ex. 4 | MgCO₃ | One surface | With pores of X < Y | Layered | A | B |
| | (30 wt %) | layer | | | | |
| Ex. 5 | Al₂O₃ | One surface | With pores of X < Y | Layered | B | B |
| | (30 wt %) | layer | | | | |
| Ex. 6 | MgO | Both surface | With pores of X < Y | Layered | A | B |
| | (30 wt %) | layers | | | | |
| C. Ex. 1 | — | Without | — | Layered | D | A |
| C. Ex. 2 | Laser | One surface | X and Y are | Layered | D | B |
| | irradiation | layer | substantially equal | | | |
| | | | or Y < X | | | |
| C. Ex. 3 | MgO | Entirety | With pores of X < Y | Porous | A | D |
| | (Mixed entirely | | | | | |
| | in material) | | | | | |
| C. Ex. 4 | MgO | One surface | X and Y are | Layered | D | B |
| | (Sprinkled over | layer | substantially equal | | | |
| | material surface) | | | | | |

In each of Examples 1 to 6, a pore forming agent-containing resin layer(s) (polyamide acid varnish containing a pore forming agent) was laminated on one or both surfaces of a resin sheet (polyimide sheet) to yield a laminated resin sheet. The laminated resin sheet was subjected to heat treatment, so that a graphite sheet was produced. Each of the graphite sheets (1) to (6) thus obtained was a surface layer porous graphite sheet having, on one or both sides thereof, a porous layer(s). The porous layer(s) of each of the graphite sheets (1) to (6) included pores each having a pore diameter X measured on the surface(s) of the porous layer(s) and a pore diameter Y measured inside the porous layer(s), the pore diameter Y being larger than the pore diameter X. From this, it is considered that each of the graphite sheets (1) to (6) had a certain level or more of adhesiveness with respect to the ceramic.

Meanwhile, the graphite sheet (1a) was a graphite sheet having a surface layer that was not porous. Thus, the graphite sheet (1a) did not have adhesiveness to the ceramic, and therefore was completely stripped off from the ceramic at the interface therebetween.

In each of the graphite sheets obtained by the production methods of Comparative Examples 2 and 4, the pores included in the porous layer had the pore diameter X measured on the surface of the graphite sheet and the pore diameter Y measured inside the porous layer, the pore diameters X and Y being substantially equal to each other. Thus, each of the graphite sheets (2a) and (4a) did not have adhesiveness to the ceramic, and therefore was completely stripped off from the ceramic at the interface therebetween.

The material from which the graphite sheet (3a) of Comparative Example 3 was made was the resin sheet containing the pore forming agent, and therefore the graphite sheet (3a) was porous in its entirety. Thus, the graphite sheet (3a) had a low thermal conductivity in an in-plane direction of the graphite sheet and accordingly had a poor heat dissipation property.

### INDUSTRIAL APPLICABILITY

The present invention is applicable to production of composite materials, for example. The composite materials thus produced can be used as, e.g., heat dissipation members for multilayer ceramic substrates and the like.

### REFERENCE SIGNS LIST

10: Graphite layer
20: Porous layer
22: Pore
30: Resin sheet
40: Pore forming agent-containing resin layer
42: Pore forming agent
50: Laminated resin sheet
100: Surface layer porous graphite sheet
100′: Surface layer porous graphite sheet
500: Composite material

1. A surface layer porous graphite sheet comprising:
a graphite layer; and
a first porous layer arranged on a first major surface of the graphite layer, wherein
the first porous layer comprises pores that extend from a surface of the first porous layer into an inside portion of the first porous layer, each pore having a pore surface diameter X that is measured at the surface of the first porous layer and a pore inner diameter Y that is measured in the inside portion of the first porous layer and that is larger than the pore surface diameter X,
in a cross section of the surface layer porous graphite sheet as viewed in a direction perpendicular to the layering direction of the graphite layer and the first porous layer, a porosity of an area A is larger than a porosity of an area B,
where:
the area A is an area corresponding to 20% of a thickness of the surface layer porous graphite sheet as measured towards the graphite layer from the surface of the first porous layer; and
the area B is an area of a thickness of the surface layer porous graphite sheet not including the area A.

2. The surface layer porous graphite sheet as set forth in claim 1, wherein
the surface layer porous graphite sheet has a thermal conductivity in an in-plane direction of not less than 800 W/mK.

3. A composite material comprising:
a surface layer porous graphite sheet recited in claim 1; and
a base laminated with the surface layer porous graphite sheet.

4. An electronic device comprising a composite material recited in claim 3.

5. A method for producing a surface layer porous graphite sheet, comprising the steps of:
providing a laminated resin sheet including
a resin sheet; and
a pore forming agent-containing resin layer laminated on a first surface of the resin sheet, the pore forming agent-containing resin layer containing a pore forming agent that is volatilized upon heated; and
subjecting the laminated resin sheet to heat treatment to graphitize the laminated resin sheet, the heat treatment being carried out at a temperature equal to or higher than a temperature at which the pore forming agent is volatilized.

6. The method according to claim 5, wherein
the pore forming agent is at least one selected from the group consisting of a metal oxide, a metal salt, a metal nitride, a metal carbide, and a metal powder.

7. The method according to claim 5, wherein
the pore forming agent is at least one selected from the group consisting of magnesium oxide, magnesium carbonate, and aluminum oxide.

8. The surface layer porous graphite sheet of claim 1, further comprising
a second porous layer arranged on a second major surface of the graphite layer,
the second porous layer comprising pores that extend from a surface of the second porous layer into an inside portion of the second porous layer, each pore having a pore surface diameter X that is measured at the surface of the second porous layer and a pore inner diameter Y that is measured in the inside portion of the second porous layer and that is larger than the pore surface diameter X, wherein
in the cross section of the surface layer porous graphite sheet, a porosity of area A′ is larger than a porosity of an area B,
wherein:
the area A′ is an area on a side of the surface layer porous graphite sheet opposite to area A, area A′ corresponding to 20% of a thickness of the surface layer porous graphite sheet as measured towards the graphite layer from the surface of the second porous layer.

9. The surface layer porous graphite sheet of claim 8, wherein
the surface layer porous graphite sheet has a thermal conductivity in an in-plane direction of not less than 800 W/mK.

10. The method according to claim 5, wherein in the step of providing a laminated resin sheet, a pore forming agent-containing resin layer is laminated on a second surface of the resin sheet that is opposite to the first surface, the pore forming agent-containing resin layer containing a pore forming agent that is volatilized upon heated.

11. A composite material comprising:
a surface layer porous graphite sheet recited in claim 2; and
a base laminated with the surface layer porous graphite sheet.

12. A composite material comprising:
a surface layer porous graphite sheet recited in claim 8; and
a base laminated with the surface layer porous graphite sheet.

13. An electronic device comprising a composite material recited in claim 8.

14. The method according to claim 9, wherein
the pore forming agent is at least one selected from the group consisting of a metal oxide, a metal salt, a metal nitride, a metal carbide, and a metal powder.

15. The method according to claim 9, wherein
the pore forming agent is at least one selected from the group consisting of magnesium oxide, magnesium carbonate, and aluminum oxide.
